(19) United States
(12) Patent Application Publication
(10) Pub. No.: US 2006/0188091 A1
(43) Pub. Date: Aug. 24, 2006

(54) PORTABLE ELECTRONIC DEVICE WITH A KEYBOARD MECHANISM

(76) Inventor: Ming-Te Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,583

(22) Filed: Feb. 13, 2006

(30) Foreign Application Priority Data
Feb. 23, 2005 (TW) 094105452

(51) Int. Cl. H04M 1/00; H04M 9/00

(52) U.S. Cl. 379/433.01

(57) ABSTRACT

A portable electronic device includes a housing including at a hole, an elastic structure including at an actuator wedged in the hole of the housing, and a circuit board installed below the housing. A metal dome is located corresponding to the actuator for outputting a key signal when pressed.

### BACKGROUND OF THE INVENTION

1. Field of the Invention

The present invention relates to a portable electronic device with a keyboard mechanism, and more particularly, to a portable electronic device with a keyboard mechanism using in combination of an actuator and an elastic structure.

2. Description of the Prior Art

In highly developed information communication systems in the modern information society, electronic devices are widely utilized in every area. For instance, the utilization of a convenient and lightweight mobile phone device has become a way of communication in our daily life; users can easily exchange and share information, experiences, and opinions through the convenience of the mobile phone device. The mobile phone progressed tremendously in recent years and various types of mobile phones are continuously developed. The increasing utilization has created a demand in production as mobile phones become more common. This is causing the technology of mobile phones to mature with the trend of moving towards smaller multi-functional phones. The important issue now is how to design a more convenient mobile phone for the user to utilize.

Please refer to FIG. 1 and FIG. 2. FIG. 1 is a drawing of a portable electronic device 10 in the prior art, and FIG. 2 is an exploded diagram of the portable electronic device 10 in the prior art. The portable electronic device 10 can be a mobile phone, a personal digital assistant (PDA), and so on. The portable electronic device 10 includes an upper casing 12 and a keyboard module 14. The keyboard module 14 includes a plastic keypad 142 wedged into a hole 16 of the upper casing 12, a plastic holder 144 installed under the plastic keypad 142, and a rubber casing 146 installed under the plastic holder 144 for pressing a metal dome on a circuit (not shown in FIG. 1 and FIG. 2) in order to output a corresponding key signal. The plastic holder 144 can hold the relative position of the plastic keypad 142 and the rubber casing 146 and can increase the structural intensity of the keyboard module 14.

The available space in which the keyboard module 14 is positioned has gradually become smaller due to the increasing size of a display of the portable electronic device 10. But for convenience of operating the keyboard module 14, it would be best to enlarge an area of each key of the keyboard module 14. Therefore, a hole 16 is positioned on the upper casing 12 corresponding to the area of the plastic keypad 142, and the plastic keypad 142 can be installed inside the hole 16. The hole 16 is formed corresponding to the whole area of the plastic keypad 142 instead of each key of the plastic keypad 142 so that there is no gap between the keys of the plastic keypad 142 and the area of each key can be enlarged. In this way, the connection between the plastic keypad 142 and the upper casing 12 is on the rim of the hole 16, so the constraint of the plastic keypad 142 provided by the upper casing 12 is on the rim of the hole 16. Hence the structural strength of the upper casing 12 is reduced, and the buckling deformation of the center part of the plastic keypad 142 can occur due to lack of constraint on the center part of the plastic keypad 142. The result of this is the gaps between the keys increase, and the keys sway and become loose easily.

### SUMMARY OF THE INVENTION

It is therefore a primary objective of the claimed invention to provide a portable electronic device with a keyboard mechanism having the combination of an actuator and an elastic structure for solving the above-mentioned problem.

According to claimed invention, a portable electronic device includes a housing including a hole, an elastic structure including an actuator wedged in the hole of the housing, and a circuit board installed below the housing. At least one metal dome is located corresponding to the actuator on the circuit board for outputting a key signal when pressed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is drawing of a portable electronic device in the prior art.

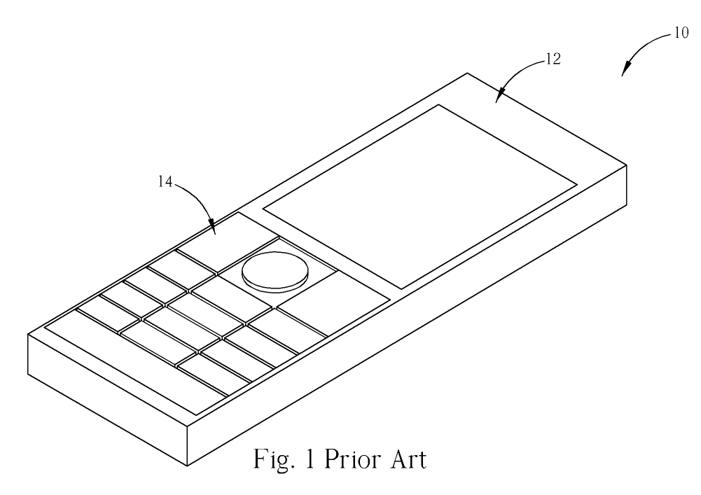

FIG. 2 is an exploded diagram of the portable electronic device in the prior art.

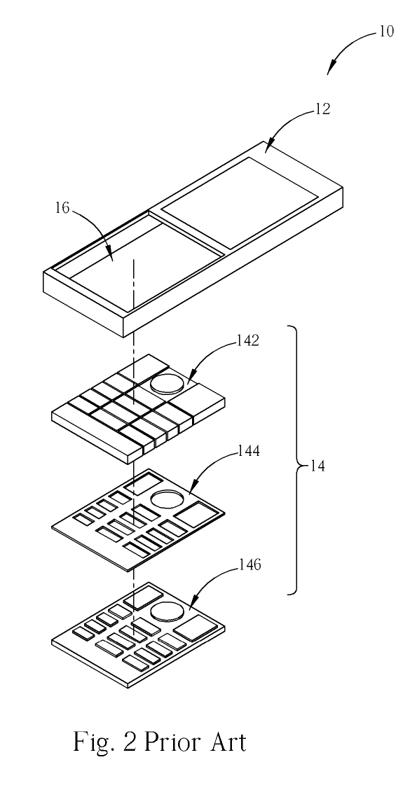

FIG. 3 is an exploded diagram of a portable electronic device according to the present invention.

FIG. 4 is a drawing of an elastic structure.

FIG. 5 is a diagram of the elastic structure being combined with a hole of a housing.

FIG. 6 is a diagram illustrating an actuator not pressing a metal dome.

FIG. 7 is a diagram illustrating the actuator pressing the metal dome.

### DETAILED DESCRIPTION

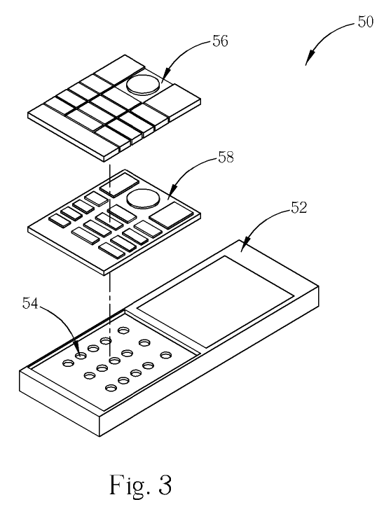

Please refer to FIG. 3. FIG. 3 is an exploded diagram of a portable electronic device 50 according to the present invention. The portable electronic device 50 can be a mobile phone or a personal digital assistant (PDA), and so on. The portable electronic device 50 includes a housing 52 including a plurality of holes 54, a keyboard casing 56 which can be made of plastic material, and an elastic structure 58 installed between the keyboard casing 56 and the housing 52. That is, the elastic structure 58 can be positioned inside the hollow cavity of the keyboard casing 56 and the keyboard casing 56 can protect the elastic structure 58. When a user presses down the keyboard casing 56, a downward force is applied to the elastic structure 58. The elastic structure 58 can be made of rubber.

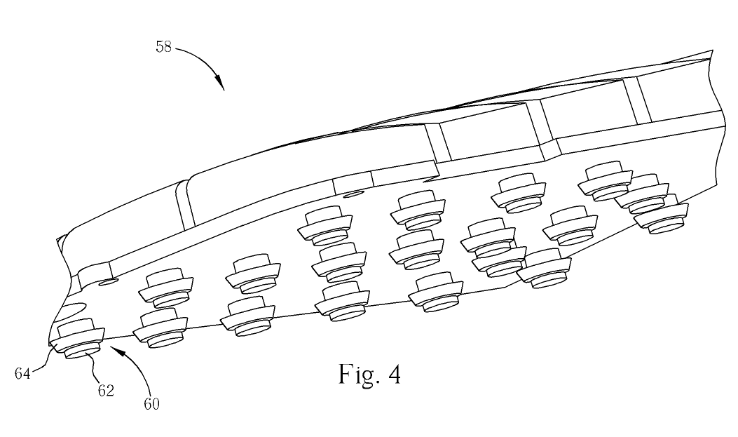

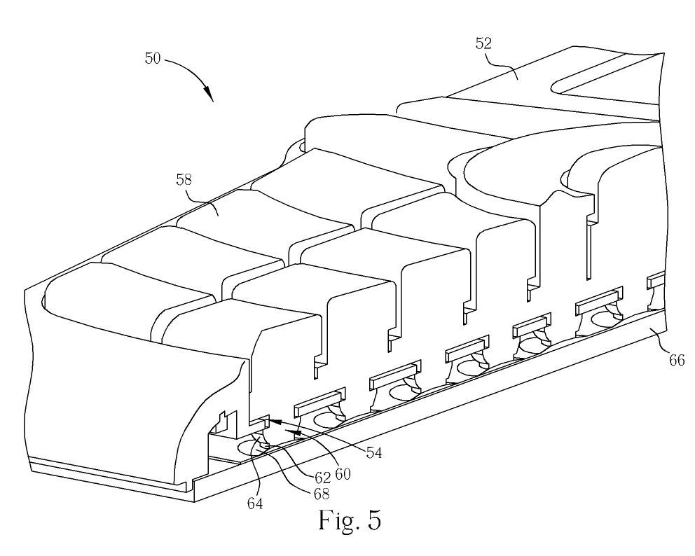

Please refer to FIG. 4 and FIG. 5. FIG. 4 is a drawing of the elastic structure 58, and FIG. 5 is a diagram of the elastic structure 58 being combined with the holes 54 of the housing 52. The elastic structure 58 includes a plurality of actuators 60 wedged in the corresponding holes 54 of the housing 52. Each of the actuators 60 includes a cylindrical structure 62 and an annular structure 64 around the cylindrical structure 62, and each of the actuators 60 has a shape like a mushroom. The cylindrical structure 62 is connected to the annular structure 64 to create a monolithic structure. The outer diameter of the annular structure 64 is greater than the diameter of the hole 54 of the housing 52. Because the annular structure 64 is flexible, the annular structure 64 can be deformed by a force and be inserted through the hole 54 of the housing 52. When the annular structure 64 passes through the hole 54 of the housing 52, the annular structure 64 will then recover to the original un-deformed shape. Because the outer diameter of the annular structure 64 is greater than the diameter of the hole 54 of the housing 52, the actuator 60 can be wedged in the hole 54 of the housing tightly. The structure of the actuators 60 are not limited to a mushroom shape. The actuators 60 can also be formed in other shapes which can make a tight combination with the hole 54.

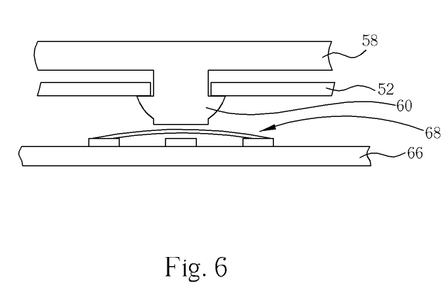

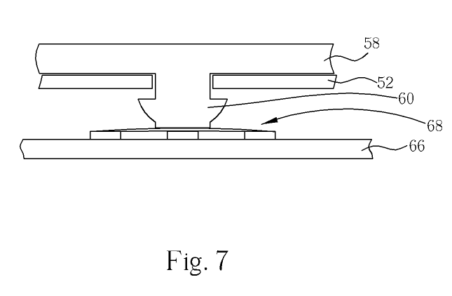

The portable electronic device 50 includes circuit board 66 installed below the housing 52. A plurality of metal domes 68 are located in the position corresponding to the actuators 60 of the elastic structure 58 on the circuit board 66 for outputting a key signal when any of the actuators 60 is pressed. Please refer to FIG. 6 and FIG. 7. FIG. 6 is a diagram illustrating the actuator 60 not pressed on the metal dome 68, and FIG. 7 is a diagram illustrating the actuator 60 pressed on the metal dome 68. When the user presses down one key of the keyboard casing 56, the key of the keyboard casing 56 will transfer a force to the part of the elastic structure 58 corresponding to the key. The actuator 60 corresponding to the key is pressed down to actuate the corresponding metal dome 68. The metal dome 68 is deformed from the shape in FIG. 6 to the shape in FIG. 7 for conducting electricity between the two ends and the center part on the circuit board 66 to output a corresponding key signal.

In contrast to the conventional portable electronic device, the portable electronic device according to the present invention includes a keyboard mechanism having the combination of the actuator and the elastic structure so that the actuator of the elastic structure can be used as a component for fixing with the housing instead of using additional components, such as plastic holder. This helps reducing the cost of the keyboard mechanism. In addition, there is no need to create a hole in the housing in an area corresponding to the area of the keyboard casing, there is no large hole on the housing, and the structural strength of the upper casing will not be decreased. Hence there is no need to apply any additional components, such as a plastic holder, to enhance the structure strength, thereby reducing the cost of the keyboard mechanism. Furthermore, because the actuator is wedged in the corresponding hole, the elastic structure can be fixed on the housing tightly and the gaps between the keys are small, improving the user's feel for the keyboard module of the portable electronic device according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a housing comprising a hole;
an elastic structure comprising an actuator wedged in the hole of the housing; and
a circuit board installed below the housing comprising a metal dome located corresponding to the actuator for outputting a key signal when pressed.

2. The portable electronic device of claim 1 further comprising a keyboard casing wherein the elastic structure is installed between the keyboard casing and the housing.

3. The portable electronic device of claim 1 wherein the actuator of the elastic structure comprises a cylindrical structure and an annular structure around the cylindrical structure, and the outer diameter of the annular structure is greater than the diameter of the hole of the housing.

4. The portable electronic device of claim 3 wherein the cylindrical structure is connected to the annular structure to create a monolithic structure.

5. The portable electronic device of claim 2 wherein the keyboard casing is made of plastic material.

6. The portable electronic device of claim 1 wherein the elastic structure is made of rubber.

7. A portable electronic device comprising:
a housing comprising a plurality of holes;
an elastic structure comprising a plurality of actuators, each wedged in the corresponding holes of the housing; and
a circuit board, installed below the housing, comprising a plurality of metal domes located corresponding to each of the actuators for outputting key signals when pressed.

8. The portable electronic device of claim 7 further comprising a keyboard casing wherein the elastic structure is installed between the keyboard casing and the housing.

9. The portable electronic device of claim 7 wherein each of the actuators of the elastic structure comprises a cylindrical structure and an annular structure around the cylindrical structure, and the outer diameter of the annular structure is greater than the diameter of the hole of the housing.

10. The portable electronic device of claim 9 wherein the cylindrical structure is connected to the annular structure to create a monolithic structure.

11. The portable electronic device of claim 8 wherein the keyboard casing is made of plastic material.

12. The portable electronic device of claim 7 wherein the elastic structure is made of rubber.
